(19) United States
(12) Patent Application Publication
(10) Pub. No.: US 2005/0138974 A1
(43) Pub. Date: Jun. 30, 2005

(54) Door of drum-type washing machine, method of manufacturing door with hairline sheet of drum-type washing machine, and method of manufacturing hairline sheet for door

(75) Inventors: Young Hoon Ha, Masan-si (KR); Bo Yoen Kim, Changwon-si (KR); Jong Seog Gim, Changwon-si (KR); Ji Chang Son, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/992,673

(22) Filed: Nov. 22, 2004

(30) Foreign Application Priority Data
Dec. 30, 2003 (KR) 10-2003-0100251
Dec. 30, 2003 (KR) 10-2003-0100252
Dec. 30, 2003 (KR) 10-2003-0100253
Dec. 30, 2003 (KR) 10-2003-0100254
Dec. 30, 2003 (KR) 10-2003-0100255

(51) Int. Cl. D06F 37/00; B08B 3/12; D06F 29/00

(52) U.S. Cl. 68/23 R; 68/3 R; 29/527.1; 29/428

(57) ABSTRACT

A door of a drum-type washing machine, a method of manufacturing a door having hairlines for the drum-type washing machine, and a method of manufacturing a hairline sheet for the door are disclosed herein. The door of the drum-type washing machine comprises a door frame hingably provided to a front surface of the drum-type washing machine, and a door glass provided to a central hole opened through the door frame. The door frame is provided on the front surface thereof with a multiple ring-shaped hairline sheet. The door frame is reinforced by means of the hairline sheet, and enhanced in an overall aesthetic appearance of the door. The hairline sheet can be conveniently replaced with a new one, if necessary, so that, when the surface of the door is severely damaged or contaminated, these can be overcome by replacing the damaged or contaminated hairline sheet with the new one.

### BACKGROUND OF THE INVENTION

1. Field of the Invention

The present invention relates to a door of a drum-type washing machine, and more particularly, to a door of a drum-type washing machine, which has hairlines formed on a front surface of the door, thereby reinforcing the door and enhancing an aesthetic outer appearance of the washing machine, a method of manufacturing a door having hairlines of the drum-type washing machine, and a method of manufacturing a hairline sheet for the door.

2. Description of the Related Art

Generally, washing machines are used for removing dirt and strains from clothes by virtue of a mechanical operation of the washing machines. Among the washing machines, a drum-type washing machine washes laundry by means of friction between a drum, horizontally installed in the washing machine to be rotated by a driving force of a motor, and the laundry contained together with wash water and detergent in the drum, and provides advantageous effects of substantially preventing the laundry from being damaged and entangled with each other, and of washing the laundry by way of pounding and rubbing the items of the laundry with each other.

FIG. 1 is a perspective view illustrating a conventional drum-type washing machine, FIG. 2 is a section side elevation illustrating the conventional drum-type washing machine, and FIG. 3 is a cross-sectional view taken along line A-A of FIG. 2.

As shown in FIGS. 1 and 2, the conventional drum-type washing machine comprises a cabinet 2 defining an outer appearance of the washing machine, a tub 4 suspended by means of a spring 3 inside the cabinet 2, a drum 5 installed in the tub 4 to wash laundry therein, a lifter 6 formed on an inner surface of the drum 5 to raise the laundry to a predetermined height and then allow the laundry to be dropped from the predetermined height due to gravity, a motor 7 mounted at a rear side of the tub 4 to generate power, a cabinet cover 22 attached at a front side of the cabinet 2 and having a laundry entrance 24 formed through the cover 22 to allow the laundry to be input or output therethrough, and a door 20 provided to the cabinet cover 22 to open or close the laundry entrance 24, thereby preventing the laundry from exiting from the laundry entrance 24.

Here, a gasket 8 is provided between the tub 4 and the door 20 to function as a packing member in order to relieve an impact resulting from rotation of the drum 5 while preventing water from overflowing to the outside of the washing machine.

Additionally, the washing machine is provided at an upper portion thereof with a top plate 9 to form an upper surface of the washing machine, and at a lower portion thereof with a base 10 to form a bottom surface of the washing machine. A drainage pump 11 and a drainage hose 12 are provided beneath the tub 4 to both circulate and discharge wash water, respectively. A wash water-feeding hose 13, a wash water-feeding valve 14, and a detergent box 15 are embedded beneath the top plate 9 to feed the water and the detergent into the tub 4.

Moreover, as shown in FIG. 3, the door 20 of the conventional drum-type washing machine comprises a ring-shaped door frame 30 hingably provided to the cabinet cover 22, a door hinge 40 having both ends respectively connected to the door frame 30 and the cabinet cover 22 to hingably support the door frame 30, and a door glass 50 installed at a central hole 30a opened through the door frame 30 to allow an inner circumstance of the drum 5 to be observed therethrough.

The door frame 30 is generally formed of a plastic material by means of injection molding, and comprises a front door frame 32 provided at the front side of the washing machine and having a grip 36 formed at one side of the door frame 30, and a rear door frame 34 provided at the rear side of the front door frame 32 and having one end of the door hinge 40 connected to the rear door frame 34. The rear door frame 34 has at least one hook 37 protruded at one side thereof, and the cabinet cover 22 has at least one hook hole 38 formed through the cabinet cover 22 to be coupled with the hook 37.

The door glass 50 has a peripheral edge fixed between the front door frame 32 and the rear door frame 34 to seal the central hole 30a of the door frame 30.

Meanwhile, since the design of the product has been recently regarded as an important factor in determining a commodity value of a product in addition to performance and durability of the product, it has become a trend of the drum-type washing machine industry to develop various models considerably focusing on an outer appearance, colors, texture feeling, and the like of the product when manufacturing a new product, in order to satisfy an aesthetic desire of consumers.

However, the door of the conventional drum-type washing machine has the door frame 30 formed of the plastic material by means of the injection molding, and thus, it does not provide a luxurious sensation to the consumer in view of the outer appearance, lowering the commodity value of the product.

Also, largeness is a recent trend of the drum-type washing machine industry, thereby causing the laundry entrance 24 and the door 20 to be enlarged. As a result, the door frame 30 must have a sufficient strength in order to support a weight of the enlarged door glass 50. However, since the door frame 30 is formed of the plastic material by means of the injection molding, there is a problem of difficulty in securing sufficient strength of the door glass.

In order to solve the problems as described above, the door frame 30 may be directly formed of a metallic material having high strength while realizing a luxurious appearance. However, in this case, there are problems of increased material costs and difficulty in surface finishing for enhancing the texture feeling.

### SUMMARY OF THE INVENTION

The present invention has been made to solve the above problems, and it is an object of the present invention to provide a door of a drum-type washing machine, designed to reinforce a door frame, to force water splashed upon drawing laundry from the washing machine to be maintained within a hairline portion, thereby preventing a front side of the drum-type washing machine from being contaminated, and to enhance an overall aesthetic appearance of the door, a method of manufacturing a door having hairlines, and a method of manufacturing a hairline sheet for the door.

In accordance with one aspect of the present invention, the above and other objects can be accomplished by the provision of a door of a drum-type washing machine, comprising: a door frame hingably provided to a front side of the drum-type washing machine; and a door glass provided to a central hole opened through the door frame, wherein the door frame is formed on a front surface thereof with a multiple ring-shaped hairline portion.

In accordance with one embodiment of the present invention, the door frame may have a ring-shaped mounting recess formed on the front surface thereof, and the hairline portion may be formed on an outer surface of a hairline sheet mounted on the mounting recess.

The hairline sheet may be formed of stainless steel.

The hairline sheet may be mounted on the mounting recess by way of press fitting.

The hairline sheet may be fixed to a bottom surface of the mounting recess by means of a bonding member.

Alternatively, the hairline sheet may be fixed to the mounting recess by means of a fastening member.

The fastening member may have latching protrusions formed to one of the door frame and the hairline sheet, and latching holes formed to the other.

The latching protrusions may be protruded on an inner surface and an outer surface of the mounting recess of the door frame, respectively, and the latching grooves may be formed on an inner peripheral surface and an outer peripheral surface of the hairline sheet bent to closely contact the inner surface and the outer surface of the mounting recess, respectively.

Each of the latching protrusions may have a sloped surface in a direction of the hairline sheet being inserted into the mounting recess so that the hairline sheet may be easily fitted into the mounting recess.

The hairline portion may be directly formed on a surface of the door frame.

The door frame may be made of a non-metallic material by means of injection molding to allow the hairline portion to be formed on the surface of the door frame, and the surface of the door frame having the hairlines formed thereon may be plated with a metallic material.

The door frame may be formed of a plastic material by means of the injection molding, and the surface of the door frame having the hairlines formed thereon may be formed with a chrome-plated layer.

Alternatively, the hairline portion may be formed by way of scratching the front surface of the door frame.

Additionally, the front surface of the door frame may be plated with a metallic material, and the hairline portion may be formed on a metal-plated layer.

A protective coating may be formed on a surface of the metal-plated layer having the hairlines formed thereon.

The protective coating may be formed of a transparent material having various colors.

In accordance with another aspect of the present invention, the object is accomplished by the provision of a method of manufacturing a door having hairlines, comprising the steps of: forming a texture feeling of hairlines to form the hairlines to an injection mold for the door frame by way of an etching process such that the hairlines may be formed on a front surface of the door frame upon injecting the door frame; injecting the door frame with a plastic material by use of the injection mold having the hairlines formed therein; and plating an outer surface of the door frame having the hairlines formed thereon with chrome.

When forming the texture feeling of the hairlines, the hairlines may be formed to have a multiple ring-shape by way of a photo-etching process in a cavity of the injection mold.

In accordance with yet another aspect of the present invention, the object is accomplished by the provision of a method of manufacturing a hairline sheet for a door of a drum-type washing machine, comprising the steps of: cutting a plurality of hairline sheet pieces from a stainless steel plate; welding the plurality of hairline sheet pieces to form a ring-shaped hairline sheet; finishing welded portions of the hairline sheet; and forming a texture feeling of hairlines on a finished surface of the hairline sheet.

The hairline sheet pieces may have arc shapes dividing the hairline sheet with an identical angle, and be provided by cutting the stainless steel plate.

### BRIEF DESCRIPTION OF THE DRAWINGS

The foregoing and other objects and features of the present invention will be more clearly understood from the following detailed description taken in conjunction with the accompanying drawings, in which:

FIG. 1 is a perspective view illustrating a conventional drum-type washing machine;

FIG. 2 is a section side elevation illustrating the conventional drum-type washing machine;

FIG. 3 is a cross-sectional view taken along line A-A of FIG. 2;

FIG. 4 is a cross-sectional view illustrating a door of a drum-type washing machine according to a first embodiment of the present invention;

FIG. 5 is a perspective view illustrating the door of the drum-type washing machine according to the first embodiment of the present invention;

FIG. 6 is an exploded perspective view illustrating the door of the drum-type washing machine according to the first embodiment of the present invention;

FIG. 7 is a block diagram illustrating a method of manufacturing a hairline sheet for the door of the drum-type washing machine according to the first embodiment of the present invention;

FIG. 8 is a diagrammatic view illustrating the method of manufacturing the hairline sheet for the door of the drum-type washing machine according to the first embodiment of the present invention;

FIG. 9 is a cross-sectional view illustrating a main part in a door of a drum-type washing machine according to a second embodiment of the present invention;

FIG. 10 is a partially cut-away perspective view illustrating the main part in the door of a drum-type washing machine according to the second embodiment of the present invention;

FIG. 11A is a cross-sectional view illustrating a hairline sheet of the door according to the second embodiment of the present invention before the hairline sheet is bent;

FIG. 11B is a cross-sectional view illustrating an upper surface of the door according to the second embodiment of the present invention, from which the hairline sheet is dissembled;

FIG. 12 is a cross-sectional view illustrating a door of a drum-type washing machine according to a third embodiment of the present invention;

FIG. 13 is a plan view illustrating the interior of an injection mold for a front door frame of the door according to the third embodiment of the present invention;

FIG. 14 is a block diagram illustrating a method of manufacturing the door having hairlines of the drum-type washing machine according to the third embodiment of the present invention;

FIG. 15 is a cross-sectional view illustrating a door of a drum-type washing machine according to a fourth embodiment of the present invention; and

FIG. 16 is a block diagram illustrating a method of manufacturing the door having hairlines of the drum-type washing machine according to the fourth embodiment of the present invention.

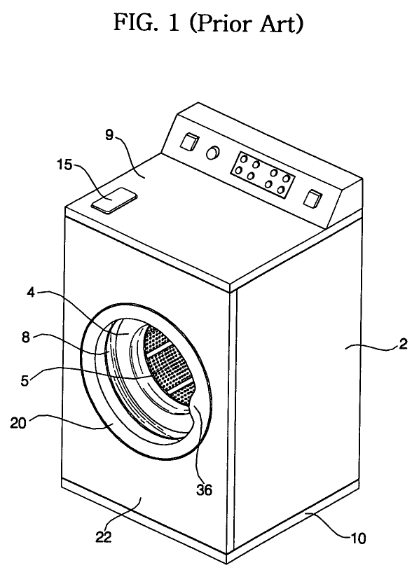

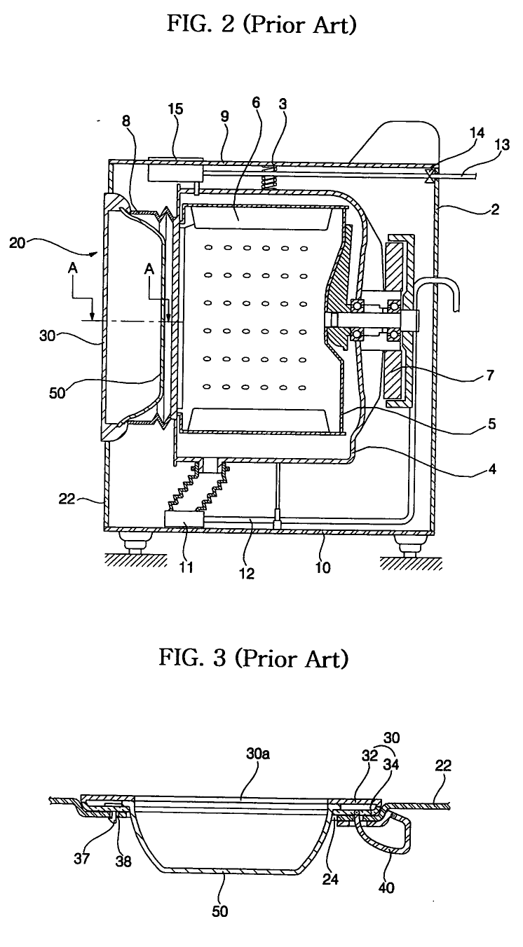

### DESCRIPTION OF THE PREFERRED EMBODIMENTS

Preferred embodiments of a door of a drum-type washing machine, a method of manufacturing the door having hairlines for the drum-type washing machine, and a method of manufacturing a hairline sheet for the door will now be described in detail with reference to the accompanying drawings.

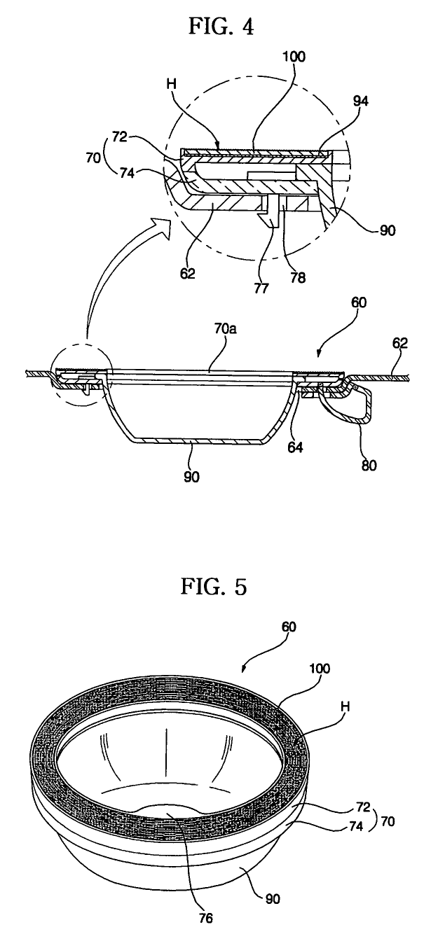

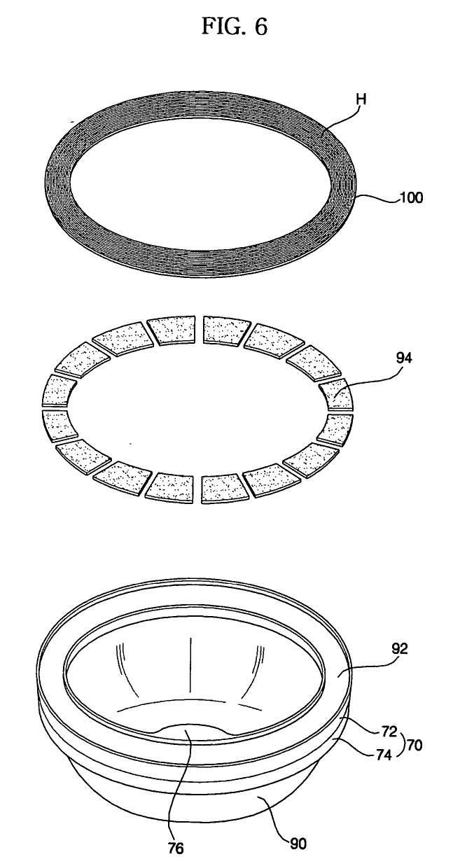

FIG. 4 is a cross-sectional view illustrating a door of a drum-type washing machine according to a first embodiment of the present invention, FIG. 5 is a perspective view illustrating the door of the drum-type washing machine according to the first embodiment of the present invention, and FIG. 6 is an exploded perspective view illustrating the door of the drum-type washing machine according to the first embodiment of the present invention.

As shown in FIGS. 4 to 6, a door 60 of a drum-type washing machine according to the first embodiment of the invention comprises a ring-shaped door frame 70 hingably provided to a cabinet cover 62 having a laundry entrance 64 formed through the cabinet cover 62, a door hinge 80 having both ends respectively connected to the door frame 70 and the cabinet cover 62 to hingably support the door frame 70, a door glass 90 installed at a central hole 70a opened through the door frame 70 to allow an inner circumstance of a drum to be observed therethrough, and a hairline sheet 100 attached to a front surface of the door frame 70 to impart a luxurious texture feeling to the door 60.

The door frame 70 comprises a front door frame 72 provided to the front surface of the door frame 70 and having a grip 76 formed at one side of the door frame 70, and a rear door frame 74 provided to the rear side of the front door frame 72 and having one end of the door hinge 80 connected to the rear door frame 74.

The rear door frame 74 has at least one hook 77 protruded at one side thereof, and the cabinet cover 62 has at least one hook hole 78 formed through the cabinet cover 62 at a position corresponding to the hook 77, so that the hook 77 is fitted into the hook hole 78, thereby allowing the door 60 closing the laundry entrance 64 to be fixed thereto.

The front door frame 72 and the rear door frame 74 are formed of a plastic material having an excellent injection characteristic and a light weight.

The door glass 90 has a peripheral edge fixed between the front door frame 72 and the rear door frame 74, and seals the central hole 70a opened through the door frame 70 as the front door frame 72 is coupled to the rear door frame 74.

The hairline sheet 100 is processed to form multiple ring-shaped hairlines H on a front surface of the hairline sheet 100, and is then press fitted into a mounting recess 92 formed on the front surface of the door frame 70.

The front door frame 72 has the mounting recess 92 formed on the front surface thereof to mount the hairline sheet 100, and having a multiple ring-shape on the front door frame 72.

The hairline sheet 100 is a thin ring-shaped panel, and formed of stainless steel. The hairline sheet 100 has a plurality of ring-shaped hairlines H formed on the front surface of the hairline sheet 100 in order to exhibit the luxurious texture feeling.

Here, the hairline sheet 100 may be cut as a complete ring shape from a stainless steel plate. Alternatively, it may be formed by way of cutting a plurality of divided segments from the stainless steel plate and then coupling the divided segments.

The hairlines H consist of very fine lines achieved by way of scratching the front surface of the hairline sheet 100 with a sharp tool, and have different radius from each other on the front surface of the ring-shaped hairline sheet 100.

Accordingly, the door 60 may not only be reinforced by means of the hairline sheet 100 formed of a metallic material, but also have the luxurious texture feeling due to the hairlines H of the hairline sheet 100. Of course, in order to enhance an aesthetic outer appearance of the door 60, the surface of the front door frame 72 is preferably plated with a material similar to that of the hairline sheet 100.

The hairline sheet 100 constructed as described above is press fitted into the mounting recess 92 of the front door frame 72. Accordingly, the hairline sheet 100 may be manufactured to have a size enabling the hairline sheet 100 to be press fitted into the mounting recess 92.

Alternatively, the hairline sheet 100 is fixed to the mounting recess 92 of the front door frame 72 by means of a bonding member 94.

Representatively, the bonding member 94 is an adhesive or a double-sided adhesive tape, and is previously disposed on a bottom surface of the mounting recess 92 before the hairline sheet 100 is press fitted into the mounting recess 92, thereby fixing the hairline sheet 100 into the mounting recess 92.

A method of manufacturing the door having the hairlines for the drum-type washing machine according to the first embodiment of the present invention will now be described hereinafter.

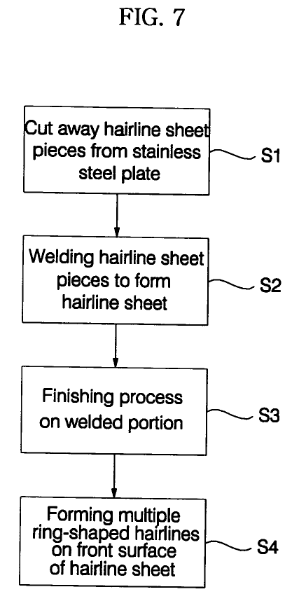

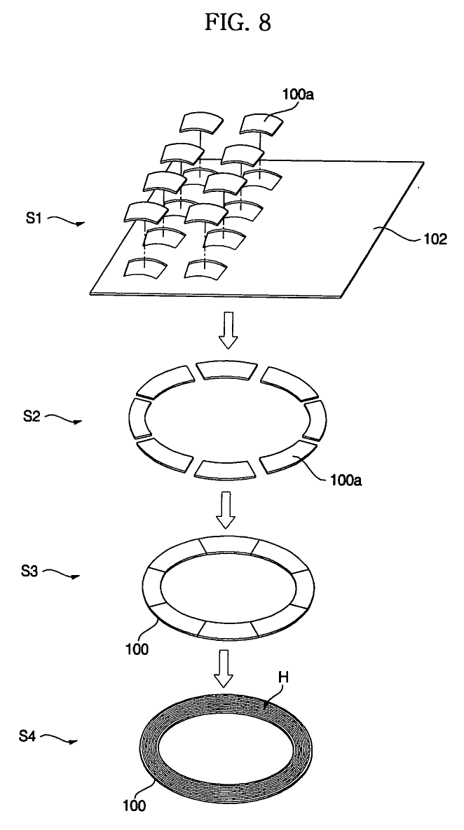

FIG. 7 is a block diagram illustrating the method of manufacturing a hairline sheet for the door of the drum-type washing machine according to the first embodiment of the present invention, and FIG. 8 is a diagrammatic view illustrating the method of manufacturing the hairline sheet for the door of the drum-type washing machine according to the first embodiment of the present invention.

First, a ring-shaped hairline sheet 100 is cut away from a stainless steel plate 102, and is then scratched on the front surface thereof by means of a sharp tool such that a plurality of hairlines H having different radius from each other are formed on the front surface of the hairline sheet 100.

The hairline sheet 100 is processed to have a size allowing the hairline sheet 100 to be press fitted into the mounting recess 92 of the front door frame 72. The mounting recess 92 of the door frame 70 has a bottom surface disposed with a double-sided adhesive tape 94.

That is, as the hairline sheet 100 is fitted into the mounting recess 92, the hairline sheet 100 is pressed and fixed into the mounting recess 92, and at the same time, the rear side of the hairline sheet 100 is bonded and fixed to the bottom surface of the mounting recess 92 by the double-sided adhesive tape 94.

Thus, the hairline sheet 100 can be conveniently provided to the door frame 70 only by an operation of fitting the hairline sheet 100 into the mounting recess 92.

As the hairline sheet 100 is fitted into the mounting recess 92 of the door frame 70 as described above, the door frame 70 can be reinforced due to the hairline sheet 100 formed of the stainless material.

As a result, even though the weight of the door glass 90 is increased due to largeness of the door 60 according to a recent trend of enlarging the drum-type washing machine, the door frame 70 is reinforced, and thus more stably supports the door glass 90.

Meanwhile, more specifically, according to the method of manufacturing the hairline sheet 100 for the door of the drum-type washing machine, as illustrated in FIGS. 7 and 8, in the step of cutting the hairline sheet, a plurality of hairline sheet pieces 100a are cut away from the stainless steel plate 102 in order to manufacture the hairline sheet 100 (Step S1).

Here, the stainless steel plate 102 is a flat plate member having a predetermined area, and the hairline sheet pieces 100a are cut away from the stainless steel plate 102 by pressing.

The plurality of hairline sheet pieces 100a have arc shapes having an identical angle, and the complete ring-shaped hairline sheet 100 is formed by connecting a predetermined number of hairline sheet pieces 100a.

That is, the hairline sheet pieces 100a have construction wherein the hairline sheet 70 is divided into a plurality of segments in the circumferential direction with an identical angle, and are formed to have an identical arc shape of a predetermined angle.

In the step of welding, the hairline sheet pieces 100a prepared in the step of cutting are connected to each other by welding, thereby forming the ring-shaped hairline sheet 100 (Step S2).

At this time, the hairline sheet pieces 100a have both ends connected to each other by welding.

In the step of finishing, welded portions of the hairline sheet 100 formed in the step of welding are grinded (Step S3).

Accordingly, the front surface of the hairline sheet 100 has a smooth surface, and is then returned to its original color since the portions changed in color due to welding is removed from the front surface of the hairline sheet 100.

In the step of forming a texture feeling of hairlines, the hairlines H are formed on the front surface of the hairline sheet 100 grinded in the step of finishing (Step S4).

That is, in a state wherein the front door frame 72 is installed to a rotational jig (not shown) and a scratching tool closely contacts the front surface of the front door frame 72 with a predetermined pressure, one of the jig and the scratching tool is rotated, and the front surface of the front door frame 72 is then scratched by the scratching tool, thereby forming the plurality of ring-shaped hairlines on the front surface of the hairline sheet 100.

Accordingly, the method of manufacturing the hairline sheet 100 as described above can prevent unnecessary consumption of the stainless steel plate 102 in comparison to a method of directly cutting the ring-shaped hairline sheet 100 from the stainless steel plate 102.

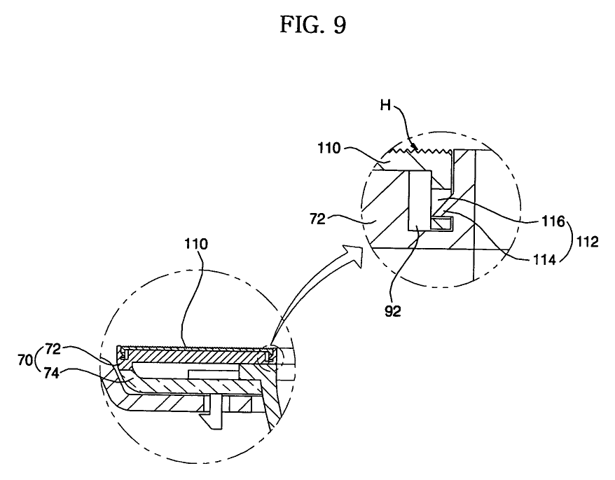

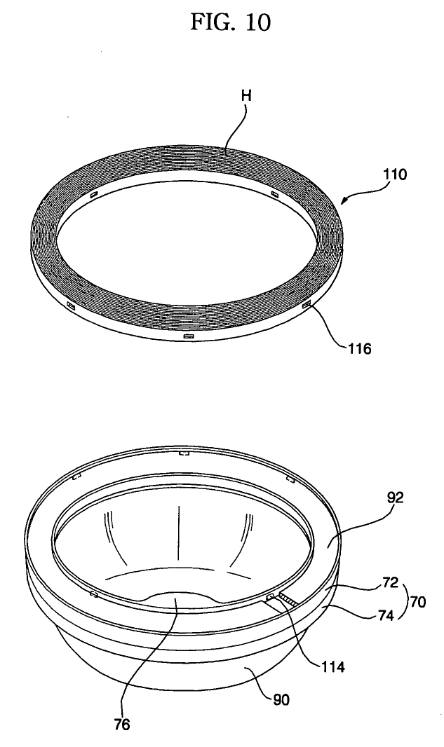

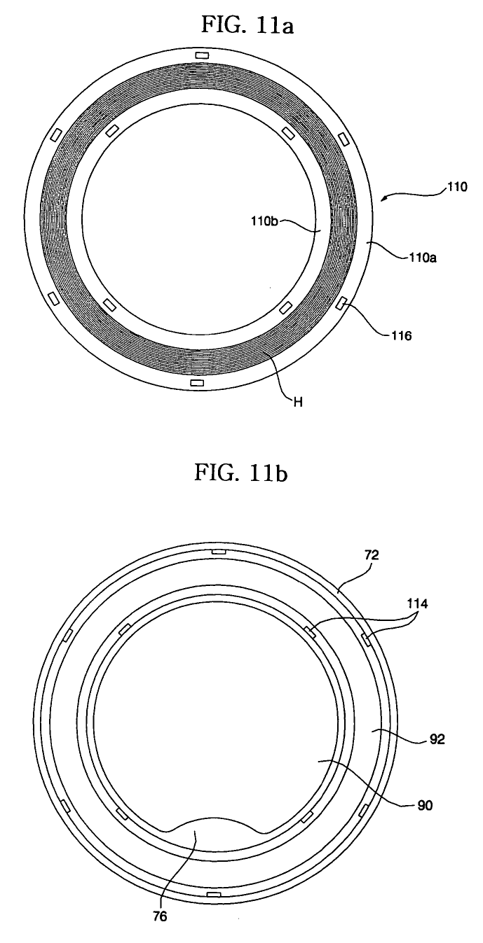

FIG. 9 is a cross-sectional view illustrating a main part in a door of a drum-type washing machine according to a second embodiment of the present invention, FIG. 10 is a partially cut-away perspective view illustrating the door of the drum-type washing machine according to the second embodiment of the present invention, FIG. 11A is a cross-sectional view illustrating a hairline sheet of the door according to the second embodiment of the present invention before the hairline sheet is bent, and FIG. 11B is a cross-sectional view illustrating an upper surface of the door according to the second embodiment of the present invention from which the hairline sheet is detached.

For reference, construction the same as or similar to those of the first embodiment will be referred by the same reference numerals as those of the first embodiment, and detailed description thereof will be omitted.

As shown in FIGS. 9 to 11A and 11B, the door of the drum-type washing machine according to the second embodiment of the invention has the same construction as that of the first embodiment, except for hairlines H formed on a front surface of a front door frame in such a manner that a hairline sheet 110 is fixed to a mounting recess 92 formed on the front surface of the door frame 70 by means of a fastening member 112.

The fastening member 112 has latching protrusions 114 formed to the mounting recess 92, and latching holes 116 formed to the hairline sheet 110 to allow the latching protrusions 114 to be fitted and latched to the latching holes 116, respectively.

The latching grooves 116 are formed on an inner peripheral surface 110a and an outer peripheral surface 110b of the hairline sheet 110, which are bent downwardly to closely contact both an inner surface and an outer surface of the mounting recess 92, respectively.

Thus, when the hairline sheet 110 is fitted into the mounting recess 92, the latching protrusions 114 are fitted and latched to the latching holes 116, thereby allowing the hairline sheet 110 to be fixed to the mounting recess 92.

At this time, the hairline sheet 110 has a U-shaped cross section, and the mounting recess 92 is depressed corresponding to the hairline sheet 110, thereby providing a U-shaped cross section. Accordingly, the hairline sheet 110 can be more stably seated into the mounting recess 92.

Each of the latching protrusion 114 has a sloped surface formed thereon in a direction of hairline sheet 110 being fitted into the mounting recess 92, thereby allowing the hairline sheet 110 to be easily fitted into the mounting recess 92 while it does not have the sloped surface in the direction of the hairline sheet 110 being detached from the mounting recess 92, thereby preventing the hairline sheet 110 from being unintentionally released from the mounting recess 92.

The latching holes 116 and the latching protrusions 114 correspond to each other, and plurality of latching holes 116 and latching protrusions 114 are formed on the hairline sheet 100 and the mounting recess 92 in the circumferential direction to be spaced a predetermined distance from each other, respectively.

A method of manufacturing the door having the hairlines of the drum-type washing machine according to the second embodiment of the present invention will now be described hereinafter.

First, a ring-shaped hairline sheet 100 is cut away from a stainless steel plate 102 to have a predetermined size, and is then scratched on the front surface thereof by means of a sharp tool, such that a plurality of hairlines H having different radius from each other are formed on the front surface of the hairline sheet.

Additionally, the hairline sheet 110 has an inner peripheral surface 110a and an outer peripheral surface 110b extended to each other, and a plurality of latching holes 116 are formed on the inner peripheral surface 110a and the outer peripheral surface 10b, respectively, while being spaced from each other in the circumferential direction.

The inner and outer peripheral surfaces 110a and 110b of the hairline sheet 110 having the latching grooves 116 formed thereon are bent downwardly at portions where the hairlines H are not formed, such that the inner and outer peripheral surfaces 110a and 110b can closely contact both the inner and outer surfaces of the mounting groove 92 upon mounting the hairline sheet 110 into the mounting recess 92 of the door frame 70.

That is, when the hairline sheet 110 is mounted into the mounting recess 92 of the door frame 70, bent portions of the hairline sheet 110 closely contact the inner and outer sides of the mounting recess 92, so that latching protrusions 114 of the mounting recess 92 are fitted and latched to the latching grooves 116.

At this time, each of the latching protrusions 114 has a sloped surface in the direction of the hairline sheet 110 being fitted into the mounting recess 92, thereby allowing the hairline sheet 110 to be easily fitted into the mounting recess 92, while it does not have the sloped surface in the direction of the hairline sheet 110 being detached from the mounting recess 92, thereby preventing the hairline sheet 110 from being unintentionally released from the mounting recess 92.

Accordingly, the hairline sheet 110 can be conveniently mounted on the front surface of the door in such a manner that, after the hairlines H and the latching holes 116 are formed on the hairline sheet 110, the hairline sheet 110 with the inner and outer peripheral surfaces 110a and 110b bent downwardly is fitted into the mounting recess 92 of the door frame 70.

Meanwhile, since other description for the method of manufacturing the door having the hairlines for the drum-type washing machine are the same as those of the first embodiment, the detailed description thereof will be omitted.

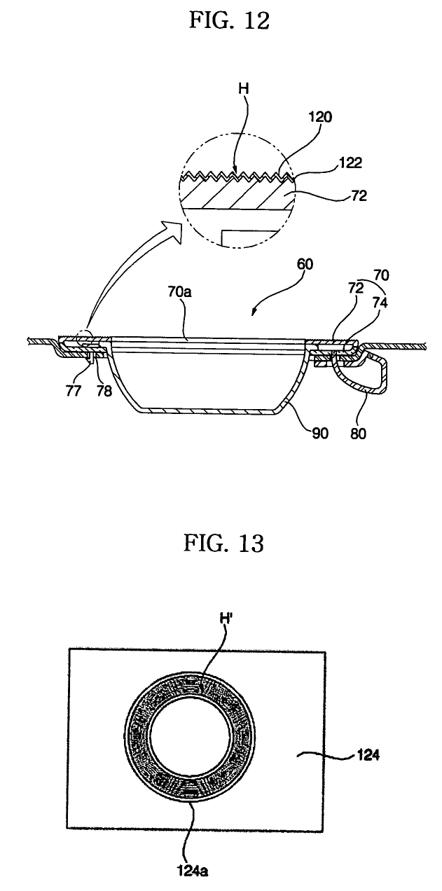

FIG. 12 is a cross-sectional view illustrating a door of a drum-type washing machine according to a third embodiment of the invention, and FIG. 13 is a plan view illustrating the interior of an injection mold for a front door frame of the door according to the third embodiment of the invention.

For reference, construction the same as or similar to those of the first embodiment will be referred by the same reference numerals as those of the first embodiment, and detailed description thereof will be omitted.

As shown in FIGS. 12 and 13, the door of the drum-type washing machine according to the third embodiment of the invention has the same construction as that of the first embodiment, except for a hairline portion 120 integrally formed to a front surface of a door frame 70 and plated with a metallic material.

A hairline portion 120 consists of multiple ring-shaped hairlines H formed on the front surface of the front door frame 72, and is integrally formed to the front surface of the front door frame 72 concurrently when injecting the front door frame 72.

That is, as shown in FIG. 13, an injection mold 124 of the front door frame 72 has a cavity 124a forming the front surface of the front door frame 72 and having hairlines H′ formed therein, so that, as the front door frame 72 is injected by use of the injection mold 124, the front door frame 72 is formed on the front surface with hairlines H corresponding to the hairlines H′ of the injection mold 124.

Chrome is plated on a surface of the front door frame 72 where the hairlines H are formed.

A method of manufacturing the door having the hairlines of the drum-type washing machine according to the third embodiment of the invention will now be described hereinafter.

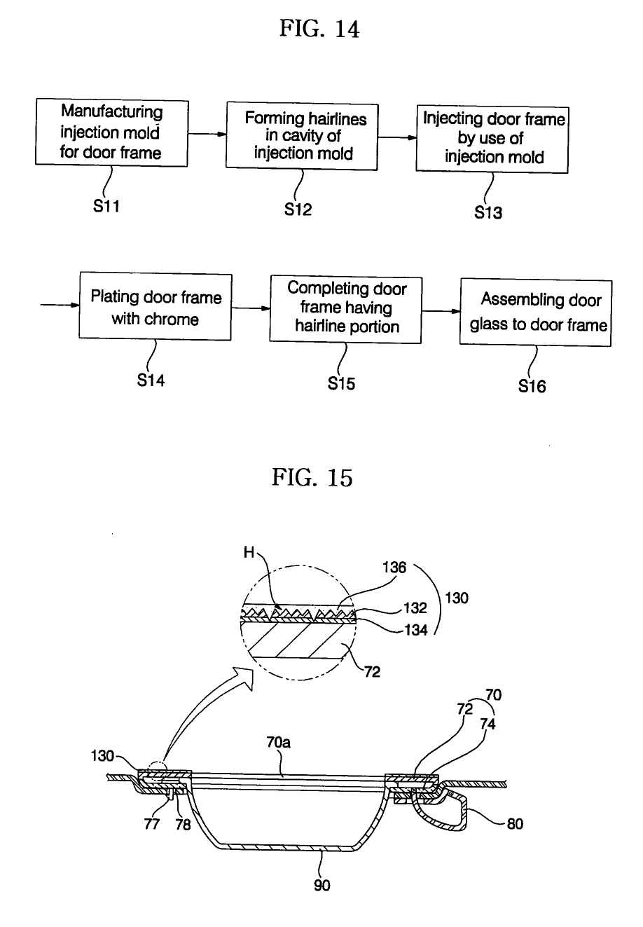

FIG. 14 is a block diagram illustrating the method of manufacturing the door having the hairlines of the drum-type washing machine according to the third embodiment of the invention.

First, in the step of forming a texture feeling of hairlines, an injection mold 124 for a front door frame 72 is formed with hairlines H′ in order to form hairlines H on a front surface of the front door frame 72 upon injecting the front door frame 72 (Steps S11 and S12).

That is, a plurality of hair lines H′ are formed in a cavity 124a of the injection mold 124 for the front door frame 72 by means of an etching process. Such an etching process for forming the hair lines H′ in the cavity 124a of the injection mold 124 includes a general photo-etching process.

In the step of injecting, the front door frame 72 is injected by use of the injection mold 124 having the hairlines H′ formed in the step of forming the texture feeling of hairlines (Step S13).

Accordingly, with the hairlines H integrally formed on the front surface of the front door frame 72, the front door frame 72 can be injected from the injection mold 124. As for a casting material for the door frame 70, a plastic material can be used, since it has a lower specific weight and strength of a predetermined level as well as an excellent injection characteristic.

In the step of plating, an outer surface of the front door frame 72 injected in the step of injecting is plated with a metallic material in order to impart a more luxurious appearance to the drum-type washing machine (Steps S14 and S15).

As for a plating material, chrome can be generally used, since it has an excellent wear resistance and provides a superior appearance. As such, the front door frame 72 exhibits a metallic luster due to a chrome-plated layer 122 formed on the front surface of the front door frame 72, thereby providing a luxurious texture feeling to the door of the drum-type washing machine in comparison to the door having a synthetic resin surface.

Accordingly, the door 60 of the drum-type washing machine has the hairlines formed on the front surface of the door frame 70 and is plated on the outer surface thereof with chrome, thereby providing a luxurious appearance to the door 60.

Thereafter, the door glass 90 is assembled to the central hole 70a of the door frame 72 configured as described above, thereby completing the door 60 (Step S16).

FIG. 15 is a cross-sectional view illustrating a door of a drum-type washing machine according to a fourth embodiment of the invention.

For reference, construction the same as or similar to those of the first embodiment will be referred by the same reference numerals as those of the first embodiment, and detailed description thereof will be omitted.

As shown in FIG. 15, the door of the drum-type washing machine according to the fourth embodiment of the invention has the same construction as that of the first embodiment, except for a hairline portion 130 comprising multiple ring-shaped hairlines H formed on an outer surface of a front door frame 70 in such a manner that the hairlines H are directly formed on a front surface of the door frame 70 by a scratching process.

The hairline portion 130 consists of the multiple ring-shaped hairlines H formed on the front surface of a front door frame 72 by the scratching process, and at this time, since the front surface of the front door frame 72 is plated with chrome to provide a chrome-plated layer 132 thereon, the multiple ring-shaped hairlines H are formed on the chrome-plated layer 132.

Meanwhile, when the hairlines H are formed on the front surface of the front door frame 72 by the scratching process, a protective coating 136 is formed on the front surface of the front door frame 72 to protect the hairlines H.

The protective coating 136 is formed of transparent materials in order to allow the hairlines H to be seen, and the color and luster of the protective coating 136 can be selected according to a fondness or style of a user.

A method of manufacturing the door having the hairlines for the drum-type washing machine according to the fourth embodiment of the invention will now be described hereinafter.

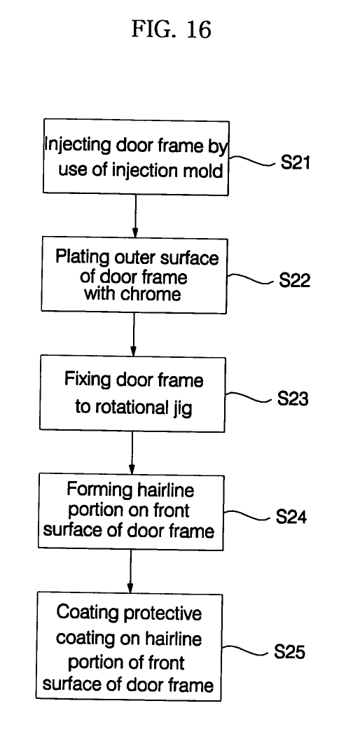

FIG. 16 is a block diagram illustrating the method of manufacturing the door having hairlines for the drum-type washing machine according to the fourth embodiment of the present invention.

First, in the step of plating, the door frame 70 formed of the plastic material by means of the injection molding is plated with a metallic material, thereby enhancing a texture feeling of the door 60 (Steps S21 and S22).

That is, the door 60 is plated with the metallic material on the front door frame 72 of the door frame 70 in order to prevent an aesthetic outer appearance of the door frame 70 from being deteriorated due to a texture feeling of the plastic material of the door frame 70. As for a plating material, chrome can be generally used, since it has an excellent wear resistance and provides a pleasant texture feeling to consumers.

In the step of forming a texture feeling of hairlines, the luxurious texture feeling is imparted to the front surface of the front door frame 72 plated in the step of plating by means of the scratching process (Steps S23 and S24).

More specifically, in a state wherein the front door frame 72 is provided to a rotational jig (not shown) and a tool for the scratching process closely contacts the front surface of the front door frame 72, one of the jig and the scratching tool is rotated, causing the chrome-plated layer 132 of the front door frame 72 to be scratched by the tool, thereby forming a plurality of ring-shaped hairlines H.

The front appearance of the door 60 is imparted with the luxurious texture feeling due to the hairlines H processed as described above, thereby enhancing the commodity value of the washing machine.

In the step of coating, a protective coating is coated on the front surface of the front door frame 72 subjected to the scratching process in the step of forming the texture feeling in order to prevent corrosion and damage of the hairline portion 130 (Step S25).

Here, although chrome used for plating of the front door frame 72 provides excellent texture feeling and stiffness, it has a problem with a lower attachment to the surface of the plastic material. Accordingly, after copper is previously plated on the surface of the front door frame 72, chrome is plated on the copper plated layer 134.

That is, after the plastic material of the front door frame 72 is previously plated with copper, which has a relatively good plating capability, forming the copper plated layer 134 on the outer surface of the front door frame 72, chrome is plated on the copper plated layer 134, thereby forming the chrome-plated layer 132.

At this time, as the scratching process is applied to the front door frame 72 in the step of forming the texture feeling in order to form the hairlines H, the chrome-plated layer 132 is peeled off, and some portion of the copper plated layer 134 is then exposed to the outside. In this regard, since copper is a metal easily subjected to corrosion unlike chrome, the copper plated layer 134 exposed to the outside by the scratching process can be easily corroded, whereby the outer appearance of the door can be deteriorated rather than improved.

In order to prevent the door frame 70 from being corroded as described above, the front surface of the front door frame 72 where the hairlines H are formed is coated with the corrosion resistant protective coating 136.

The protective coating 136 also prevents the hairlines H formed by course of the scratching process from being destroyed or damaged due to an impact, and the consumers from being damaged by the sharply scratched hairlines H.

Meanwhile, the protective coating 136 is formed of transparent materials, so that the luxurious feeling of the door 60 imparted due to plating of chrome and the hairlines H can be suitably provided to the consumers in view of visibility.

Since the color and luster of such a protective coating 136 can be selected according to the materials and methods of coating, the texture feeling can be appropriately imparted to the front surface of the front door frame 70 depending on the necessity.

As apparent from the description, according to the present invention, the door of the drum-type washing machine and the method of manufacturing the same provide the multiple ring-shaped hairlines formed on the front surface of the door frame, thereby reinforcing the door and of enhancing the aesthetic appearance of the washing machine.

As the door frame is reinforced, the door glass increased in weight due to largeness of the door can be stably supported by the door frame.

Additionally, even though wash water is splashed onto the front surface of the door upon drawing laundry from the washing machine, the water is maintained in the hairline portion, and is prevented from spreading to the outside of the door, thereby preventing the front side of the drum-type washing machine from being contaminated.

Additionally, since the hairline portion reflects or absorbs light, it protects against a dazzling phenomenon due to a metal-plated layer formed on the surface of the door frame, thereby reducing inconvenience of the user.

Additionally, the door is enhanced in the aesthetic appearance due to the hairline portion, and provides the luxurious appearance to the washing machine, thereby satisfying the aesthetic desire of the consumer and enhancing the commodity value of the drum-type washing machine.

Additionally, as the door of the drum-type washing machine and the method of manufacturing the door according to the first and second embodiments of the invention have the stainless steel hairline sheet fixed to the mounting recess, which is formed on the front surface of the door frame, the hairline sheet can be conveniently mounted on the front surface of the door frame with the operation of fitting the hairline sheet into the mounting recess of the door frame, and, even though the surface of the door is severely damaged or contaminated, these can be overcome by conveniently replacing the damaged or contaminated hairline sheet with a new one.

Additionally, the door of the drum-type washing machine and the method of manufacturing the door according to the first and second embodiments of the invention provide the hairline sheet comprising the multiple ring-shaped hairlines, which is formed on the front surface of the door frame in such a manner that, after the plurality of hairline sheet pieces are cut from the stainless steel plate and connected to each other by welding to form the hairline sheet, the welded portions of the hairline sheet are subjected to the finishing process, thereby preventing unnecessary consumption of the stainless steel plate and reducing manufacturing costs and a price of the product, resulting in enhancement of price competitiveness, in comparison to the method of directly cutting the ring-shaped hairline sheet from the stainless steel plate.

Additionally, as the door of the drum-type washing machine and the method of manufacturing the door according to the third embodiment of the invention provide the door frame, which is plated on the outer surface thereof with chrome after being injected with the plastic material through the injection mold having the hairlines formed therein by the photo-etching process, the manufacturing process of the door frame is simplified, there is an advantageous effect of enhancement in productivity of the product.

Additionally, as the door of the drum-type washing machine and the method of manufacturing the same according to the third embodiment of the invention have the hairline portion, which provides the luxurious texture feeling to the door of the drum-type washing machine, and which can be formed thereon in such a manner that, after scratching the surface of the door plated with chrome by means of the sharp tool to form the hairlines on the front surface of the door, the transparent and protective coating is coated on the hairlines, there is an advantageous effect of preventing corrosion of the hairline portion scratched on the door by means of the protective coating.

The protective coating prevents the hairlines from being damaged due to an impact, and the color and luster of the protective coating can be selected according to the fondness of the user, thereby allowing the outer appearance to be adapted in various shapes.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

1. A door of a drum-type washing machine, comprising:
a door frame hingably provided to a front side of the drum-type washing machine; and
a door glass provided to a central hole opened through the door frame,
wherein the door frame is formed on a front surface of the door frame with a multiple ring-shaped hairline portion.

2. The door as set forth in claim 1, wherein the door frame has a ring-shaped mounting recess formed on the front surface thereof, and the hairline portion is formed on an outer surface of a hairline sheet mounted on the mounting recess.

3. The door as set forth in claim 2, wherein the hairline sheet is made of stainless steel.

4. The door as set forth in claim 2, wherein the hairline sheet is mounted on the mounting recess by way of press fitting.

5. The door as set forth in claim 2, wherein the hairline sheet is fixed to a bottom surface of the mounting recess by means of a bonding member.

6. The door as set forth in claim 2, wherein the hairline sheet is fixed to the mounting recess by means of a fastening member.

7. The door as set forth in claim 6, wherein the fastening member has latching protrusions formed to one of the door frame and the hairline sheet, and latching holes formed to the other.

8. The door as set forth in claim 7, wherein the latching protrusions are protruded on an inner surface and an outer surface of the mounting recess of the door frame, respectively, and the latching grooves are formed on an inner peripheral surface and an outer peripheral surface of the hairline sheet bent to closely contact the inner surface and the outer surface of the mounting recess, respectively.

9. The door as set forth in claim 8, wherein each of the latching protrusions has a sloped surface in a direction of the hairline sheet being inserted into the mounting recess so that the hairline sheet may be easily fitted into the mounting recess.

10. The door as set forth in claim 1, wherein the hairline portion is directly formed on a surface of the door frame.

11. The door as set forth in claim 10, wherein the door frame is formed of a non-metallic material by means of injection molding to allow the hairline portion to be formed on the surface of the door frame, and the surface of the door frame having the hairlines formed thereon is plated with a metallic material.

12. The door as set forth in claim 11, wherein the door frame is formed of a plastic material by means of the injection molding, and the surface of the door frame having the hairlines formed thereon is formed with a chrome-plated layer.

13. The door as set forth in claim 10, wherein the hairline portion is formed by scratching the front surface of the door frame.

14. The door as set forth in claim 13, wherein the front surface of the door frame is plated with a metallic material, and the hairline portion is formed on a metal-plated layer.

15. The door as set forth in claim 14, wherein a protective coating is formed on a surface of the hairline portion formed on the metal-plated layer.

16. The door as set forth in claim 15, wherein the protective coating is formed of a transparent material having various colors.

17. A door of a drum-type washing machine, comprising:
a door frame hingably provided to a front side of the drum-type washing machine;
a door glass provided to a central hole opened through the door frame; and
a hairline sheet mounted on a front surface of the door flame, said sheet having multiple hairlines on an outer surface of the sheet.

18. A method of manufacturing a door having hairlines, comprising the steps of:
forming a texture feeling of hairlines to form the hairlines to an injection mold for a door frame by way of an etching process such that the hairlines may be formed on a front surface of the door frame upon injecting the door frame;
injecting the door frame with a plastic material by use of the injection mold having the hairlines formed therein; and
plating an outer surface of the door frame having the hairlines formed thereon with chrome.

19. The method as set forth in claim 18, wherein, when forming the texture feeling of the hairlines, the hairlines are formed to have a multiple ring-shape by way of a photo-etching process in a cavity of the injection mold.

20. A method of manufacturing a hairline sheet for a door of a drum-type washing machine, comprising the steps of:
cutting a plurality of hairline sheet pieces from a stainless steel plate;
welding the plurality of hairline sheet pieces to form a ring-shaped hairline sheet;
finishing welded portions of the hairline sheet; and
forming a texture feeling of hairlines to provide the hairlines on a finished surface of the hairline sheet.

21. The method as set forth in claim 20, wherein the hairline sheet pieces have arc shapes dividing the hairline sheet with an identical angle, and are provided by cutting the stainless steel plate.
